(19) United States
(12) Patent Application Publication
(10) Pub. No.: US 2008/0141156 A1
(43) Pub. Date: Jun. 12, 2008

(54) Customization of Applications on a Computing Device

(76) Inventors: Matthias Reik, Budapest (HU); Johan Carnegard, Ronneby (SE); Igor Netto, Dusseldorf (DE)

Correspondence Address: HARRITY SNYDER, L.L.P., 11350 RANDOM HILLS ROAD, SUITE 600, FAIRFAX, VA, 22030, US

(21) Appl. No.: 11/576,643

(22) PCT Filed: Oct. 10, 2005
(86) PCT No.: PCT/GB05/03829

§ 371 Date: Oct. 24, 2007

(30) Foreign Application Priority Data
Oct. 5, 2004 (GB) 0422092.7

(51) Int. Cl. G06F 3/048

(52) U.S. Cl. 715/771

(57) ABSTRACT

A computing device comprises an application framework that handles both UI controls and user input and which provides user interface (UI) services required by applications. Embedded links are established between uniquely identifiable controls and uniquely identifiable tasks or service requests, which are stored in a data store of the device. When a control is invoked, the store is examined to identify any embedded links that uniquely reference that control. The control is then modified to allow a user or operator to additionally select an option relating to the tasks or services attached to the identified embedded links and the application framework issues the identified task or service request when the user or operator selects the additional option that has been added to the control.

The invention relates to post-production customisation of the functionality of applications on a computing device.

It is common for manufactured products to be especially modified for specific customers or specific markets. In general, the costs of such customization need to be borne in addition to the usual cost of manufacturing, meaning that, if such customization occurs, either the price of the product must increase or the profit margin must decrease. Whether customization makes sense therefore depends on the utility of the modifications entailed by whichever party is to bear the cost. In other words, the key to a successful customization exercise is to maximize the usefulness of the modifications to the manufacturing process while minimizing their cost.

The necessary economic tradeoffs are particularly acute in price sensitive markets where distributors in the value chain are all seeking to differentiate themselves from their competitors. Modifying a product is a clear way of adding value and differentiating one's offering by providing something more tailored to a specific pattern of use; but at the same time, this must not be at the expense of eroding one's profit margin or giving a competitor a price advantage.

Some of the clearest examples of these economic forces at work can be found in the consumer electronics field. The manufacture and sale of advanced mobile phones is used here as one illustration of the fields in which this invention may be applied; however, the intention is not to restrict the application of this invention solely to the domain of mobile phones, as it can be generically applied across the whole range of interactive computing devices.

The term ‘interactive computing device’ should be construed to include any device which includes both a screen or other method for displaying information and also a keyboard, keypad, button array, touch screen or some other method for input such as selecting information; today this includes personal devices such as desktop computer, laptop computers, PDAs, Mobile Telephones, Smartphones, Digital Camera, Digital Music Players as well as many other industrial and domestic devices ranging from ATMs to domestic electrical apparatus (such as washing machines and televisions) to transport mechanisms including such devices, such as motor vehicles (of all forms), trains, boats and planes.

Interactive computing devices usually incorporate programmable software controls. A control can be defined as an object that produces an instant action or a visible result when manipulated by the user; common controls include pop-up, pull-down or tabbed menus, radio buttons and push buttons, hotspots and hyperlinks, checkboxes, dialogs, scroll bars and sliders, while common means of manipulation include keys, buttons, and pointing devices such as touchscreens, joysticks or mice.

Mobile phones are typically distributed by network operators whose business models depend on providing a service for their subscribers. It has become common in recent years for network operators to commission customized versions of these mobile phone products to their subscribers in order to help distinguish between the services of the respective operators.

However, in order to maintain the cost of product customization within acceptable limits, network operators usually undertake only superficial modifications to the product. These typically include cosmetic alterations such as the application of logos or bespoke colours to the exterior plastics of the phone in order to reinforce the operator's brand.

As far as the software controlling the phone is concerned, the only modifications usually made are to pre-configure existing applications or to pre-load specially written software. It is well know in the art that modification requests are equivalent to a late change in the product specification, and that such change requests are a main cause of product failure both before launch and after shipment.

Therefore the economics of software development tend to make any deeper or more fundamental customization of the inbuilt applications in mobile phones and other interactive consumer electronic devices prohibitively expensive; manufacturers and distributors are aware that complex software is architecturally fragile and that the necessary iterative build and test cycle is expensive in terms of both time and labour.

The fact that it has been economically practical only to make superficial modifications to complex software products has limited the potential usefulness of customizability. In the mobile phone area, for example, it would clearly be extremely useful for both users and network operators if modifications could somehow be embedded in existing applications instead of being overlaid by means of add-on applications.

Some examples of this customizability would be:
Modify the telephone application functionality to add a menu item to call a certain operator-specific service number
Modify the browser application functionality to add a menu item to connect to an operator-specific web site and possibly download material
Modify the messaging application to add an option to send an e-mail to a customer relations address.

Furthermore, it would be extremely useful if such embedded application modifications could not only be made as late as possible after the time of manufacture, but could also be implemented in devices after they have been sold; i.e. while they are in the possession of the end users. Over-the-air (OTA) customization, using the wireless connection built in to every phone, would be an ideal mechanism through which this could be effected.

The known ways for modification of applications can only be applied to these deficiencies separately.

Embedding modifications inside existing applications (and altering those modifications) is possible by means of causing those applications to spawn executable programs using a parent-child paradigm. It is well-known property of most operating systems (including those which run mobile phones) that this can be done; clearly, if an application is written in such a way as to search for such spawnable programs (commonly known as plug-ins) at specific points in its execution sequence, then altering the plug-in does not require the application or the low-level architecture of the operating system to be modified.

Further, the technology for altering such plug-ins in place by sending them over-the-air has existed for some time, and various forms of this have typically been exploited by users to download ring tones and games, and by network operators to send configuration data and occasional bespoke functionality to new subscribers.

However, these known methods are deficient because they are not extensible; the techniques described require that a network operator (or other agent seeking to customize inbuilt applications) knows in advance about the number and possible locations where customized functionality might need to be added, and that the manufacturer places suitable hooks in the applications at the time the device is manufactured. If a hook has not been provided at the time of manufacture, then there is no possibility of a downloaded plug-in being executed by an application or of customizing its menus and dialogs to indicate where additional functionality has been provided.

Consequently, where different parties have different views of where hooks might be needed, the manufacturer has to either support the requirements of all of them, or else decide in advance which ones are the most significant. This severely limits the utility of the possible customizations. Supporting all possible customizations by adding multiple hooks would almost certainly prove both architecturally complex and also prohibitively expensive.

Furthermore, it is not possible, using the known customization techniques, to add unanticipated customizability to a device at the post-manufacture stage. While the specific bespoke items can be changed, their number or locations cannot readily be added to or moved.

It is therefore an object of the present invention to provide an improved way of customizing applications on a computing device.

According to a first aspect of the present invention there is provided a computing device comprising
a. an application framework operable to provide user interface (UI) services that applications require in common; and
b. the application framework is operable to handle both UI controls and user input; and
c. an application's UI controls can be uniquely identified; and
d. applications can be requested to perform specific tasks or services on behalf of any arbitrary application; and
e. such tasks or service requests can be uniquely identified; and
f. embedded links can be established between uniquely identifiable controls and uniquely identifiable tasks or service requests; and
g. such embedded links can be kept in a data store in the device; and wherein
h. the application framework is arranged to examine the store when a control is invoked, to identify any embedded links that uniquely reference that control, and modify the control to allow a user or operator to additionally select an option relating to the tasks or services attached to the identified embedded links; and
i. the application framework is arranged to issue the identified task or service request if the user or operator selects the additional option that has been added to the control.

According to a second aspect of the invention there is provided a method of operating a computing device comprising an application framework for providing user interfaces services that applications require in common and for handling both UI controls and user input; an application's UI controls can be uniquely identified; applications can be requested to perform specific tasks or services on behalf of any arbitrary application; and wherein such tasks or service requests can be uniquely identified; the method comprising
a. establishing embedded links between uniquely identifiable controls and uniquely identifiable tasks or service requests; and
b. maintaining such embedded links in a data store in the device; and
c. using the application framework to examine the store when a control is invoked, identifying any embedded links that uniquely reference that control, and modifying the control in order to allow a user or operator to additionally select an option relating to the tasks or services attached to the embedded links identified; and
d. issuing the identified task or service request if the user or operator selects the additional option added to the control.

According to a third aspect of the present invention there is provided an operating system for causing a computing device according to the first aspect to operate in accordance with a method of the second aspect.

Embodiments of the present invention will now be described, by way of further example only, with reference to the accompanying drawings, in which;

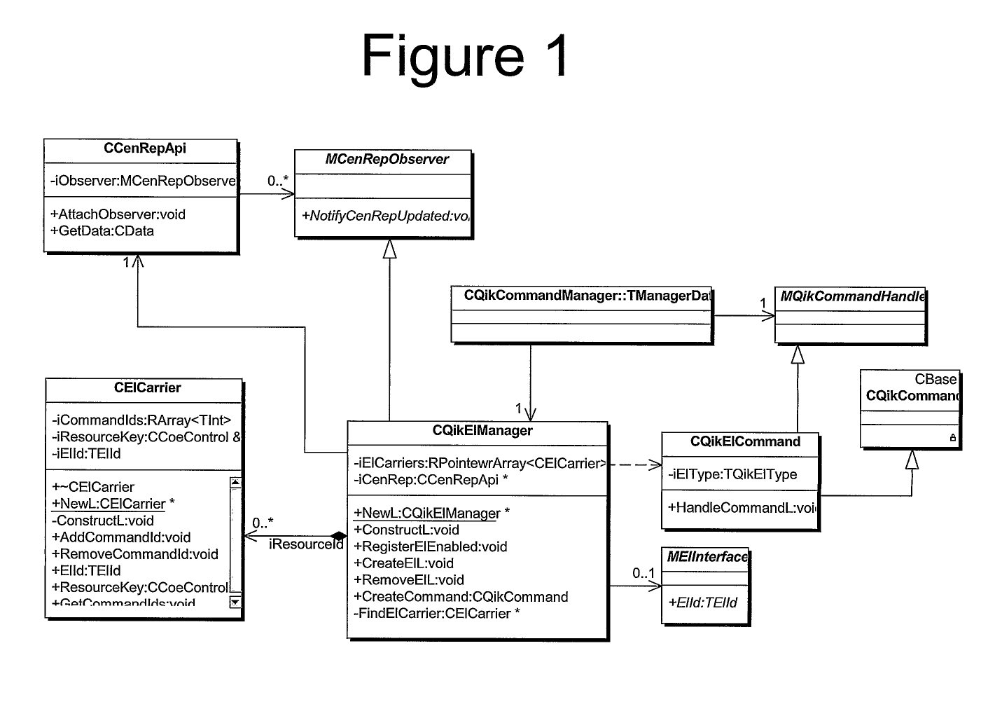

FIG. 1 shows a component overview of an application framework having customizable elements in accordance with the present invention;

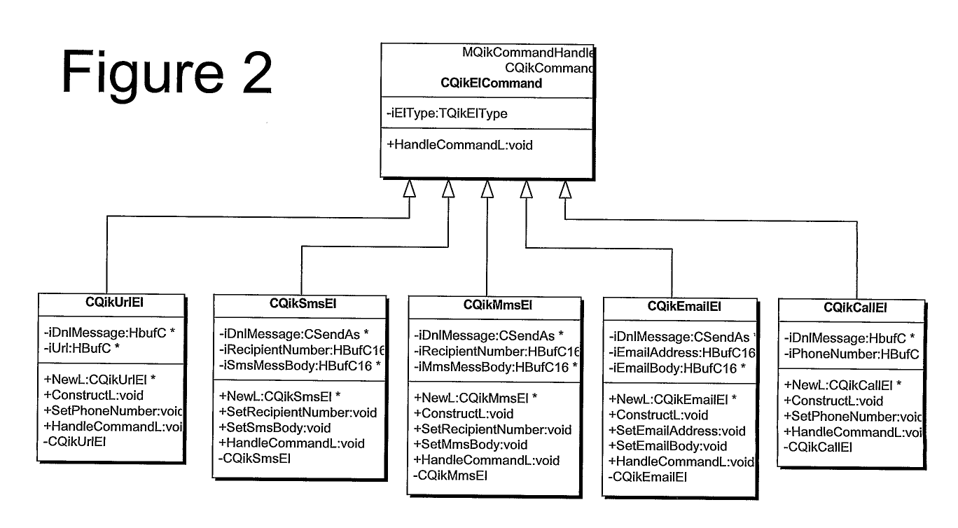

FIG. 2 shows typical embedded link (EL) command details for the framework illustrated in FIG. 1;

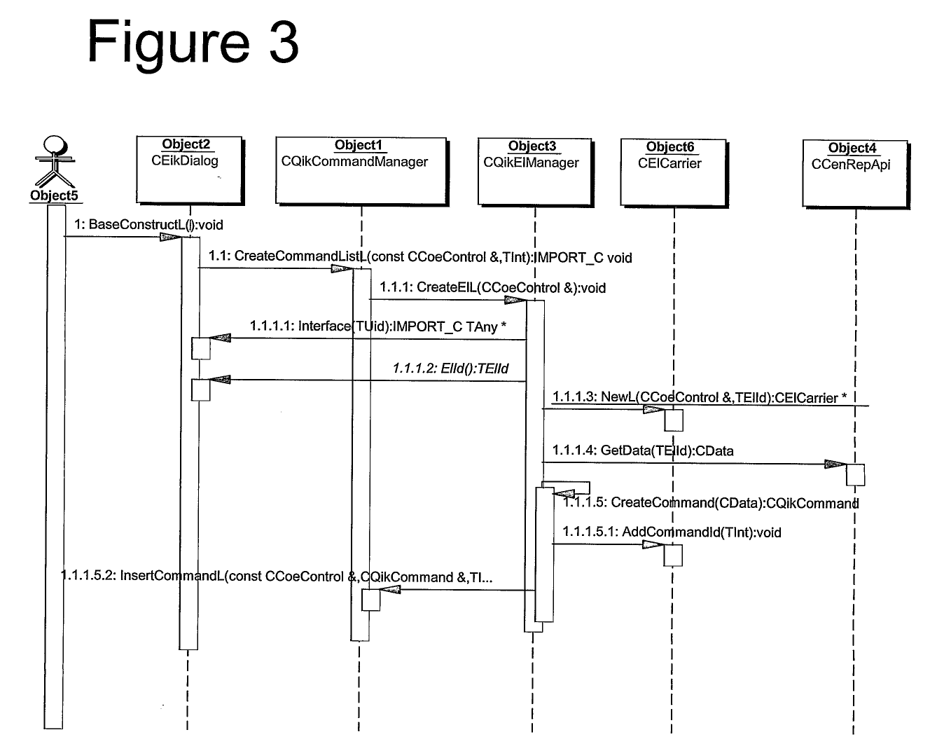

FIG. 3 shows how embedded links (ELs) may be created;

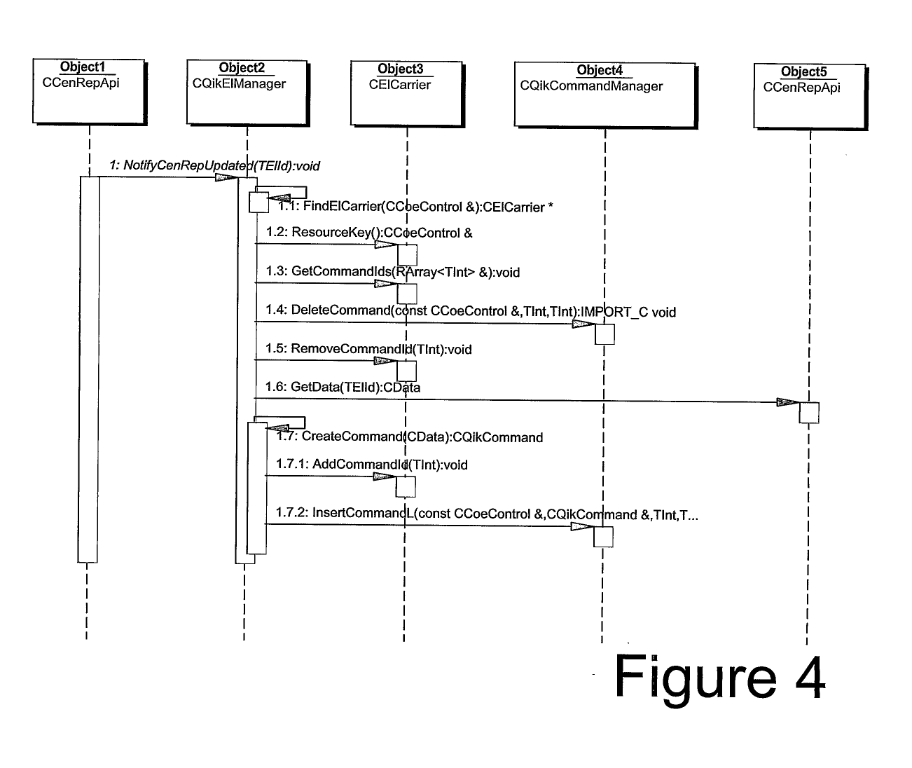

FIG. 4 shows how the Central Repository object of the operating system of the computing device may be updated; and

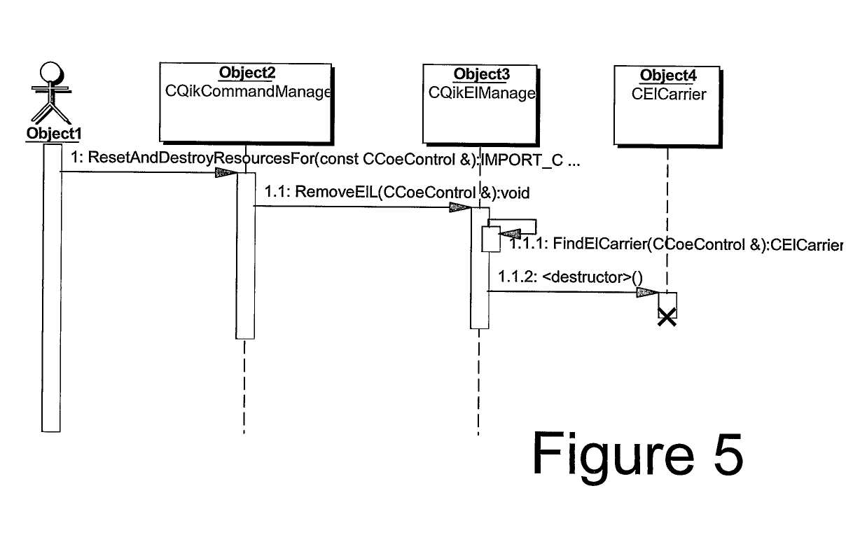

FIG. 5 shows the destruction of a UI item.

The present invention is applicable to any computing device which incorporates an operating system layer which provides a programming framework for handling the user interface (UI) elements common to all interactive applications. The Application Programming Interfaces (APIs) included in such frameworks enable (inter alia) some or all of the following tasks:
the creation of user interface controls
a framework for applications to handle user interface events
environment utilities for control creation
access to windowing functionality
handling different forms of user input.

Such an applications framework (AF) is usually provided in all current day operating systems which offer graphical user interfaces; it avoids the necessity for all applications to include separate code for handling such tasks themselves and also enables all applications to cooperatively share the UI with a common look and feel.

In the present invention, a customizable element is not directly embedded in an existing application, but is fully defined externally to the application. Such a customizable element is referred to in the context of this invention as an Externally Defined Command (EDC), and can be automatically added to any application by the AF at any place where it is invoked. The EDC can either spawn a new instance of an executable and pass it the necessary instructions, or, if the executable were already running, can use inter-process communication to pass a request. In either case, the linkage between the application's control and the EDC is known as an embedded link (EL).

With the present invention each application control is uniquely identified and each EL is also uniquely identified. This enables a database to be constructed which maps the embedded links to the controls; the exact mechanism can vary from one implementation to another, but writing tuples to the database is one possibility.

Once this database is constructed, the AF is arranged to consult the database each time it is invoked to create a control (such as a menu). If, for a particular control, an EL is found, the opportunity is taken to customize the application's control at that point, without the producer of the operating system or the application having to provide any special hooks in advance. The AF simply needs to check whether there is an embedded link corresponding to the control.

There are a number of possible mechanisms by which a control can be customized; the task is simplified because the writer of an embedded link has to know what type of control needs to be customized. The simplest mechanism is for the embedded link to be extended from a tuple to a triple, with the third element containing the customization; so in this embodiment a triple relating to a menu control includes some text that can be added to the menu.

Once the EL appears as an option in the displayed control, the correct EDC will then be invoked provided the AF is also used to accept the input.

The extensibility of this mechanism derives from the fact that the database which maps controls to ELs can be written to as well as read. Ideally, this implementation should be on a secure operating system (OS), in which the ability to write to the database is restricted to system applications with suitable permissions. The Platform Security Architecture provided by Symbian Software Ltd of London England, as described in GB Patent applications 0312191.0 (Capabilities) and 0312190.2 (Data Caging), is one example of such an OS.

Using this invention, there is no necessity for the application writer to know in advance that a customization might take place. The only limitation is that the party who defines the EL needs to ensure that both the application and the precise control to which the EDC should be attached are known before the EL is defined.

The example below shows a preferred implementation developed for the customizable UIQ user interface written by UIQ Technologies AB of Ronneby, Sweden for Symbian OS, the advanced operating system from Symbian Software Ltd. which is provided to illustrate the principles behind this invention and should not be taken as an indication that its applicability is in any way restricted to this particular operating system and user interface.

So while some familiarity with Symbian OS and UIQ is necessary to fully understand this specific implementation, the principles behind the invention as disclosed will apply to any OS with an application framework and a mechanism for invoking plug-in applications. The insights disclosed here will be readily appreciated by anyone skilled in the art of designing user interfaces and operating systems.

Some of the salient features of this specific implementation are as follows:
a Symbian OS includes an AF (sometimes known as CONE, an abbreviation of Control Environment) which has been continually enhanced in each successive OS release. This provides a framework for creating user interface controls; a framework for applications to handle user interface events; and environment utilities for control creation and access to windowing functionality.
Symbian OS can also include a Central Repository, in which case it acts as the database that maps ELs to unique controls.
Within the UIQ user interface, EDCs are implemented via a mechanism known as a Direct Navigation Link (DNL). DNLs are used to navigate directly from one application to another, usually to allow the user of the device to carry out a task as easily as possible. They typically work in a particular context, taking data from one application and passing it to another application in order to allow the data to be used directly. For example, DNLs are used in the Contacts application to allow the user to directly initiate a telephone call by tapping on a telephone number or to create an email by tapping on an email address.
UIQ also includes a Command Processing Framework (CPF), which has been described elsewhere in UK Patent Application Number 0414842.5; in this implementation, embedded links read information from the Central Repository and are added to the appropriate command list in CPF.

This mechanism can not only be used for defining ELs but also some kind of system commands, commands that are added to any application (like “hang up phone call”). In this case the application does not have to be known in forehand. In addition, it is possible to extend it to allow some kind of application interaction. The application interaction is slightly against the principle that the application is not aware of the addition, but it allows links to be customized with some context information. As an example, it would be possible to display the weather information for the correct day, when the user activates an EDC in Agenda.

Another scenario may be to provide more detailed information about the current location when standing in a GPS application.

This invention provides therefore a method of customizing applications on computing devices by making use of the fact that all advanced devices rely on application frameworks to handle common UI controls and input, combined with the ability of one application to pass requests to another (possibly spawning the second application in addition, depending on the underlying OS). Provided the application framework can uniquely identify specific controls and can uniquely identify application requests, a database can be constructed of specific controls linked to specific requests. This database of embedded links is consulted by the application framework when a control is invoked, and if a relevant embedded link uniquely referencing the control in question is present, the application framework can modify the control to add an option for the linked request. Customising any part of the device then becomes a matter simply of writing to the database.

FIG. 1 shows a component overview of an application framework having customizable elements and FIG. 2 shows typical EL Command details.

The following classes may be used to implement embedded links and externally defined commands. These classes will be readily understood by a person skilled in this art.

### CQikElManager

CQikElManager's responsibility is to keep track of all EL carriers and to read information from the Central Repository and add them to the appropriate command list in CPF.

When CreateElL( ) is called a call is made to the object provider interface of CCoeControl to obtain a pointer to a MElInterface class. This class is implemented by all UI items that can contain EL's. ElId( ) is called to get the EL id of the UI item. The id will be used by command handler to locate EL info from the CenRep. The EL type is read from the EL info and a suitable CQikElCommand specialization is created and added to the UI item's command list.

### CElCarrier

CElCarrier holds information about each UI item that contains an EL. The information consists of a TElId and a list of the command id's of the EL's associated with the UI item.

### CQikElCommand

CQikElCommand is a base class for all EL command types. It holds information about EL type. The pointer to its MQikCommandHandler is set to point to the command itself.

### CQikUrlEl

CQikUrlEl implements a URL EL. When HandleCommandL( ) is called a DNL is made to the internal browser application (QWebExternalInterface.h). The DNL contains the URL to be opened by the browser.

### CQikSmsEl

CQikSmsEl implements an SMS EL. When HandleCommandL( ) is called a DNL is made to the messaging application. The DNL contains a CSendAs object which in turn consists of a recipient number and a SMS message body.

### CQikMmsEl

CQikMmsEl implements an MMS EL. When HandleCommandL( ) is called a DNL is made to the messaging application. The DNL contains a CSendAs object which in turn consists of a recipient number and an MMS message body.

### CQikEmailEl

CQikEmailEl implements an Email EL. When HandleCommandL( ) is called a DNL is made to the email application. The DNL contains a CSendAs object which in turn consists of a recipient email address and an email message body.

### CQikCallEl

CQikCallEl implements a call EL. When HandleCommandL( ) I called a DNL is made to the telephony application. The DNL contains the phone number to be called.

### CCenRepApi

CCenRepApi encapsulates the interface of the Central Repository. The details of this class are TBD until the API of the CenRep is decided. This also counts for MCenRepObserver.

### MElInterface

MElInterface is the class the object provider interface of CCoeControl returns when asked for an interface to an EL carrier. This class must be implemented by all UI items that can contain EL's.

### TElId

TElId uniquely identifies a UI item that can contain EL's using two identifiers (UID's), one application UID and one EL UID. To handle items that do not belong to an application a system UID is registered in the application UID database. The EL UID must be unique within the scope of the application UID.

The following classes in UIQ and Symbian OS may be modified to implement this invention:

### CQikCommandManager::TManagerData

A new member is added, a CQikElManager pointer.

### CQikCommandManager

Creation of a CQikElManager object and assignment of the CQikElManager pointer in TManagerData is added in ConstructL( ).

A call to CQikElManager.CreateElL( ) is added in CreateCommandListL( ).

A Call to CQikElManager.RemoveEl( ) is added in ResetAndDestroyResourcesFor( ).

### CEikDialog

Implement the MElInterface class and MObjectProvider support.

### CQikViewBase

Implement the MElInterface class and MObjectProvider support.

In order to identify UI items, it is possible to assign EL's to three different UI items: views, dialogs and pop outs. Additional UI items might be added eventually. Each UI item that shall contain EL's should be uniquely identifiable. They are identified using a TElId identifier.

The prefix part of the TElId is an application UID. The suffix part of the TElId is an EL UID. The El UID must be unique within the scope of the application UID. There are a number of different ways to accomplish this.

One option is to use the view id for views. One concern with this solution is that neither dialogs nor pop outs have view id's. Hence, if this option is to be used view id's must be allocated for dialogs and pop outs together with the views but this has the added drawback that it might be found confusing to mix them.

Another option is to use resource id's. An advantage with this is that many UI items are created from resource files and therefore have resource id's. One drawback is that views usually are not created from resource files. Neither pop outs have resource id's. A further drawback is that the resource id's have to be consistent over time and between builds. This requires that binary compatibility issues are taken into account when changing resource files: the consistency of resource id's depends on not erasing resource names from resource files.

A third option is to use the unique id in CCoeControl. An advantage of this option is that all UI items that can contain EL's are descendants of CCoeControl and therefore have a unique id. A drawback is that not all have the unique id set. This could mean that many UI items need to be updated to be able to contain EL's. There is no support for changes of unique id's when a command list is created. This functionality can be added with limited effort required. Hence, this third option is the preferred one to use to establish a unique id. FIG. 3 shows how ELs may be created.

FIG. 4 shows how Central Repository (CenRep) may be updated and FIG. 5 shows how a UI item may be destroyed.

Although the present invention has been described with reference to particular embodiments, it will be appreciated that modifications may be effected whilst remaining within the scope of the present invention as defined by the appended claims.

1. A computing device comprising
a. an application framework operable to provide user interface (UI) services that applications require in common; and
b. the application framework is operable to handle both UI controls and user input; and
c. an application's UI controls can be uniquely identified; and
d. applications can be requested to perform specific tasks or services on behalf of any arbitrary application; and
e. such tasks or service requests can be uniquely identified; and
f. embedded links can be established between uniquely identifiable controls and uniquely identifiable tasks or service requests; and
g. such embedded links can be kept in a data store in the device; and wherein
h. the application framework is arranged to examine the store when a control is invoked, to identify any embedded links that uniquely reference that control, and modify the control to allow a user or operator to additionally select an option relating to the tasks or services attached to the identified embedded links; and
i. the application framework is arranged to issue the identified task or service request if tue user or operator selects the additional option that has been added to the control.

2. A device according to claim 1 in which an external application or agent is operable to add links between uniquely identifiable controls and uniquely identifiable task or service requests to the data store in the device where embedded links are kept.

3. A device according to claim 1 in which the data store is secured against unauthorised access.

4. A method of operating a computing device comprising an application framework for providing user interfaces services that applications require in common and for handling both UI controls and user input; an application's UI controls can be uniquely identified; applications can be requested to perform specific tasks or services on behalf of any arbitrary application; and wherein such tasks or service requests can be uniquely identified; the method comprising
a. establishing embedded links between uniquely identifiable controls and uniquely identifiable tasks or service requests; and
b. maintaining such embedded links in a data store in the device; and
c. using the application framework to examine the store when a control is invoked, identifying any embedded links that uniquely reference that control, and modifying the control in order to allow a user or operator to additionally select an option relating to the tasks or services attached to the embedded links identified; and
d. issuing the identified task or service request if the user or operator selects the additional option added to the control.

5. A method according to claim 4 in which an external application or agent can add links between uniquely identifiable controls and uniquely identifiable task or service requests to the permanent data store in the device where embedded links are kept.

6. A method according to claim 4 in which the permanent data store is secured against unauthorised access.

7. An operating system for causing a computing device to operate in accordance with a method as claimed in claim 4.

8. A device according to claim 2 in which the data store is secured against unauthorised access.

9. A method according to claim 5 in which the permanent data store is secured against unauthorised access.
